(19) United States
(12) Patent Application Publication
(10) Pub. No.: US 2026/0195058 A1
(43) Pub. Date: Jul. 9, 2026

(54) METHOD FOR PARALLEL HARDWARE INSTANCE CONFIGURATION

(71) Applicant: Sandisk Technologies, Inc., Milpitas, CA (US)

(72) Inventor: JAMES WANG, San Jose, CA (US)

(73) Assignee: Sandisk Technologies, Inc., Milpitas, CA (US)

(21) Appl. No.: 19/009,238

(22) Filed: Jan. 3, 2025

(51) Int. Cl. G06F 3/06

(52) U.S. Cl. CPC G06F 3/0632; G06F 3/0604; G06F 3/0688

(57) ABSTRACT

A storage device may initialize multiple instances of a hardware device in parallel during initialization of the storage device. The storage device may include a hardware device including multiple instances with the same configuration setting or overlapping configuration settings. A master device may be connected to a set of instances of the hardware device. The master device may include the configuration settings of connected hardware instances to be initialized during initialization of the storage device. When initializing the storage device, a controller may initialize the configuration settings of the connected hardware instances in the master device. When the configuration settings in the master device are initialized, the master device broadcasts initialized values in the configuration settings in the master device to each instance in the set of instances for the instance to initialize its configuration settings.

### BACKGROUND OF THE INVENTION

A storage device may be communicatively coupled to a host and to non-volatile memory including, for example, a NAND flash memory device on which the storage device may store data received from the host. The memory device may include multiple dies which may be divided into physical blocks and the storage device may store data in blocks on the memory device. The storage device may include hardware devices that may be configured to perform specific tasks, and the storage device may include multiple instances of the same hardware device. Each hardware instance may have a physically unique memory address. The configuration of components on the multiple instances of a hardware device may overlap or be the same. For example, the register configurations on multiple instances of a hardware device may overlap or be the same.

The hardware devices on the storage device may include initial default values. In some cases, the default values may be valid but not optimal. In addition, when the storage device is being initialized, some hardware devices may require additional register configuration beyond Power-On/Reset values. Typically one processor on the storage device may handle the initialization of the hardware devices and the processor may execute an initialization firmware to configure the registers and other components in the hardware devices.

When multiple instances of a hardware device are being configured during initialization of the storage device, even though the configuration settings may be the same or may significantly overlap, the initialization firmware may configure each hardware instance, and the initialization firmware may iterate the setup of values across the physically unique memory addresses associated with the hardware instances. The initialization firmware may thus serialize initialization of the hardware instances, wherein the initialization firmware may initialize the first hardware instance, and after that set up is complete, initialize the next hardware instance, until all the hardware instances have been initialized. While the initialization firmware is initializing the storage device including configuring multiple hardware instances one at a time, the storage device may be unable to perform other tasks.

In some cases, the hardware instances may be grouped, and the initialization firmware may drive the initialization of the hardware instances in a group. The initialization firmware may overlap the initialization of instances in a group. However, the initialization firmware may still initialize one instance in the group at a time. Serializing the initialization of the hardware instances whether individually or as members of a group may increase the initialization time of the storage device which may impact the readiness of the storage device to accept requests from the host, particularly as the number of hardware instances needing initialization increases.

To reduce the setup latency associated with initializing multiple hardware instances, the initialization firmware may be executed on multiple processors so that the initialization may be performed in parallel. However, the initialization logic may have to be replicated across the multiple processors performing the hardware initialization which may result in high duplication cost.

### SUMMARY OF THE INVENTION

In some implementations, a storage device may initialize multiple instances of a hardware device in parallel during initialization of the storage device. The storage device may include a hardware device that includes multiple instances with a set of configuration settings. The set of configuration settings may be the same configuration settings or overlapping configuration settings. A master device may be connected to a set of instances of the hardware device. The master device may include the configuration settings of connected hardware instances, wherein the set of configuration settings are to be initialized during initialization of the storage device. When initializing the storage device, a controller may initialize the configuration settings in the master device. When the configuration settings in the master device are initialized, the master device may broadcast initialized values in the configuration settings in the master device to each instance in the set of instances for the instance to initialize its configuration settings.

In some implementations, the storage device may initialize multiple instances of a hardware device during initialization of the storage device. The storage device may include a hardware device that includes multiple instances with a set of configuration settings. The set of configuration settings may be the same configuration settings or overlapping configuration settings. A master device may be connected to a set of instances of the hardware device. The master device may include the configuration settings of connected hardware instances, wherein the set of configuration settings are to be initialized during initialization of the storage device. When the configuration settings in the master device are initialized, the master device may broadcast the initialized values in the configuration settings in the master device to each instance in the set of instances for the instance to initialize its configuration settings in parallel with other instances in the set of instance. The controller may establish direct connection with a first instance to update a configuration setting in the first instance.

In some implementations, a method is provided for initializing multiple instances of a hardware device during initialization of a storage device. The method includes connecting, by a master device, to a set of instances of a hardware device having a set of configuration setting. The method also comprises including, by the controller, the set of configuration settings of connected hardware instances in the master device. The method further includes initializing, by the controller, the set of configuration settings in the master device when initializing the storage device. The method also includes broadcasting, by the master device, initialized values in the configuration settings in the master device to each instance in the set of instances for the instance to initialize its configuration settings, when the configuration settings in the master device are initialized.

### BRIEF DESCRIPTION OF THE DRAWINGS

FIG. 1 is a schematic block diagram of an example system in accordance with some implementations.

FIG. 2 is a block diagram of an example storage device for configuring multiple hardware instances in parallel with one processor in accordance with some implementations.

FIG. 3 is an example flow diagram for configuring multiple hardware instances in parallel with one processor during initialization of a storage device in accordance with some implementations.

FIG. 4 is another example flow diagram for configuring multiple hardware instances in parallel with one processor during initialization of a storage device in accordance with some implementations.

FIG. 5 is a diagram of an example environment in which systems and/or methods described herein are implemented.

FIG. 6 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

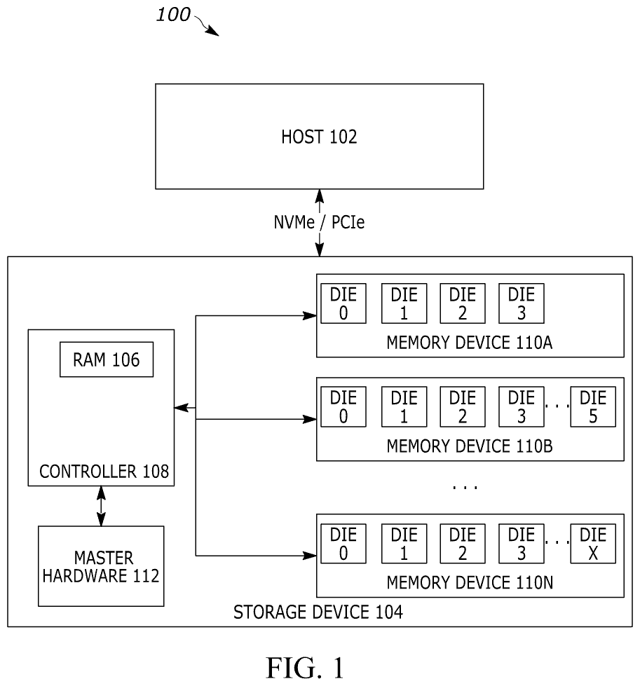

FIG. 1 is a schematic block diagram of an example system in accordance with some implementations. System 100 includes a host 102 and a storage device 104. Host 102 may transmit commands to read or write data to storage device 104. Host 102 and storage device 104 may be in the same physical location as components on a single computing device or on different computing devices that are communicatively coupled. Storage device 104, in various implementations, may be disposed in one or more different locations relative to the host 102 and storage device 104 may communicate with host 102 over a peripheral component interconnect express (PCIe) protocol and the like. Host 102 may include additional components (not shown in this figure for the sake of simplicity).

Storage device 104 may include a random-access memory (RAM) 106, a controller 108, one or more non-volatile memory devices 110a-110n (referred to herein as the memory device(s) 110), and a master hardware 112. Storage device 104 may be, for example, a solid-state drive (SSD). RAM 106 may be static RAM (SRAM) or dynamic RAM (DRAM) that may be used to cache information used on storage device 104.

Controller 108 may interface with host 102 and process foreground operations including instructions transmitted from host 102. For example, controller 108 may read data from and/or write to memory device 110 based on instructions received from host 102. Controller 108 may also execute background operations to manage resources on memory device 110. For example, controller 108 may execute garbage collection, read refresh, and other relocation functions per internal relocation algorithms to refresh, recycle, and/or relocate the data on memory device 110.

Memory device 110 may be flash based. For example, memory device 110 may be a NAND or NOR flash memory that may be used for storing host and control data over the operational life of memory device 110. Memory device 110 may include multiple dies (for example, DIE 0-DIE X) that may be divided into blocks to store data, wherein the data may be stored in various formats. Memory device 110 may be included in storage device 104 or may be otherwise communicatively coupled to storage device 104.

In addition to master hardware 112 (also referred to herein as a master device), storage device 104 may include other hardware devices (not shown) that may be configured to perform specific tasks. One or more of the other hardware devices may include multiple instances. Each of the instances of a hardware device may be associated with a physically unique memory address and the instances may have a set of configuration settings that may be the same or overlap. Master hardware 112 may include the same configuration settings as one or more hardware devices including multiple instances. For example, a first hardware device with multiple instances may include configuration settings A-F and a second hardware device with multiple instances may include configuration setting G-L. Master hardware 112 may include configuration settings A-L and may be connected to all or a subset of instances of the first and/or second hardware devices via a bus.

Master hardware 112 may know how many instances of a hardware device it is connected to and the address of each connected hardware instance and master hardware 112 may include the components in each of the connected hardware instances that may be configured when storage device 104 is being initialized. For example, master hardware 112 may know the unique physical address of each of the connected hardware instances and may include the registers, in each of the connected hardware instances, that may be configured when storage device 104 is being initialized. Master hardware 112 may map its registers or other components with the associated registers or other components in the connected hardware instances. For example, master hardware 112 may map registers A-F in master hardware 112 to registers A-F in the connected instances of the first hardware device. Master hardware 112 may also map registers G-L in master hardware 112 to registers G-L in the connected instances of the second hardware device.

To reduce setup latency and the time required to configure multiple instances with the same values using a single processor, controller 108 may initialize the components in master hardware 112 associated with a set of hardware instances. For example, when initializing storage device 104, controller 108 may provide the initial values for one or more registers (for example, registers A-F) in master hardware 112. When the configuration settings in master hardware 112 are initialized, master hardware 112 may broadcast its initialized configuration values (for example, the values for registers A-F) to the connected instances of the first hardware device. The broadcast command may include multiple input/output (IO) lines, wherein a first IO line on a bus between master hardware 112 and the connected hardware instances may be associated with a first configuration setting in master hardware 112, a second IO line on the bus between master hardware 112 and the connected hardware instances may be associated with a second configuration setting in master hardware 112, and so on. For example, IO line 0 may be associated with register A, IO line 1 may be associated with register B, IO line 2 may be associated with register C, and IO line 3 may be associated with register D, and so on. Master hardware 112 may broadcast the initialized value for register A on IO line 0, for register B on IO line 1, for register C on IO line 2, and so on. Master hardware 112 may leverage hardware-based support including, for example, Direct Memory Access and the like. Each of the connected hardware instances may listen to the IO lines and may use the values transmitted on the IO lines to update the registers and other components in the connected hardware instance during initialization of storage device 104.

When the connected instances of, for example, the first hardware device receive the broadcast sent on the bus from master hardware 112, the connected hardware instances may use the broadcast configuration values to update associated registers in parallel. For example, each connected instances of the first hardware device may use the values sent on the IO lines associated with registers A-F to update registers A-F in the instance in parallel with other connected hardware instances of the first hardware device. Controller 108 may therefore perform a single initialization of master hardware 112 and master hardware 112 may broadcast its initialized configuration to N instances of one or more hardware devices to initialize the hardware instances at the same time. Serving as an initialization bridge in the initialization flow, master hardware 112 may eliminate the need for a single processor (for example, controller 108) to perform serialized initialization of multiple instances of the same hardware device when the instances have the same or overlapping configuration settings. As such, with master hardware 112 bridging the initialization flow, controller 108 may initialize more than one hardware device with the same or overlapping configuration in a single setup process, thus reducing the initialization time of storage device 104.

In some cases, controller 108 may initiate the downstream setup of the instances connected to master hardware 112. After initializing the configuration settings in master hardware 112, controller 108 may poll on a status from master hardware 112 to know when the configuration operation on the connected hardware instances is complete. During a wait time, controller 108 may perform other setup tasks as required to overlap initialization sequences. Controller 108 may establish direct communication with a single hardware component. For example, controller 108 may establish direct communication with a first instance of the first hardware device to perform error recovery on configuration settings on the first instance. Controller 108 may also establish direct communication with a hardware component to update the configuration settings on the hardware component. Controller 108 may establish direct communication via known unique hardware mapped locations that may map each hardware instance into an addressable memory region this is accessible by controller 108.

Storage device 104 may perform these processes based on a processor, for example, controller 108 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

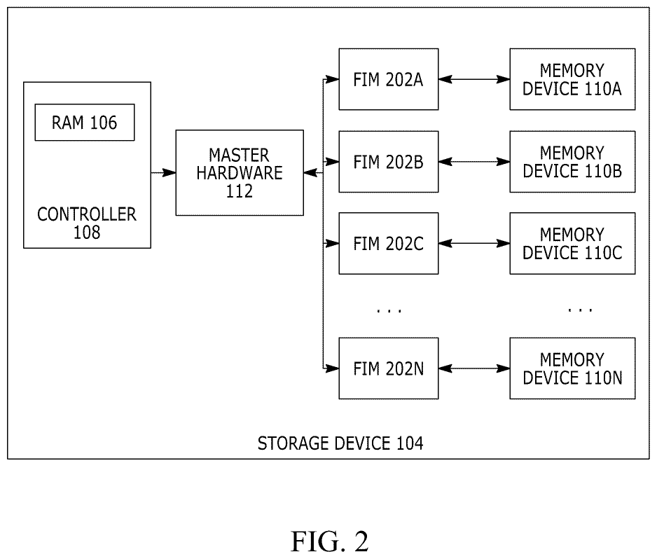

FIG. 2 is a block diagram of an example storage device for configuring multiple hardware instances in parallel with one processor in accordance with some implementations. Storage device 104 may include a random-access memory (RAM) 106, a controller 108, one or more non-volatile memory devices 110, a master hardware 112, and multiple instances of a flash interface module (FIM) (shown as FIM 202A to FIM 202N and referred to generally as FIM(s) 202). Memory device 110 may be divided into sections, and controller 108 may communicate with multiple sections of memory device 110 in parallel. Each instance of FIM may be associated with a section of memory device. For example, FIM 202A may be communicatively coupled to memory device 110A, FIM 202B may be communicatively coupled to memory device 110B, FIM 202C may be communicatively coupled to memory device 110C, and so on. As such, each instance of FIM 202 may control an interface between controller 108 and the section of memory device 110 to which the instance is communicatively coupled. In one example, storage device 104 may include up to sixteen instances of FIM 202, each of which may control four memory chips and may have a physically unique memory mapped address. Master hardware 112 may be connected to all or a subset of the instances of FIM 202 and may independently address the instances of FIM 202 connected to master hardware 112.

Each instance of FIM 202 may include a set of configuration settings that may include, for example, a number of registers. Master hardware 112 may include the same configuration settings as FIMs 202A-202N. When storage device 104 is being initialized, FIMs 202A-202N may not be started automatically. During initialization of storage device 110, controller 108 may have to initialize the values in the registers in FIMs 202A-202N to, for example, tune behavior, power, and/or change modes in FIMs 202A-202N.

When storage device 104 is being initialized, controller 108 may provide the initial values for one or more registers in FIMs 202A-202N to master hardware 112. Master hardware 112 may use the initial values to configure the registers in master hardware 112 that are also in FIMs 202A-202N. When the configuration settings in master hardware 112 are initialized, master hardware 112 may broadcast its initialized configuration values for the registers used in FIMs 202A-202N.

When FIMs 202A-202N receive the broadcast sent on the bus from master hardware 112, FIMs 202A-202N may use the register values in the broadcast message to update associated registers in parallel. As such, controller 108 may perform a single initialization of master hardware 112 and master hardware 112 may broadcast its initialized configuration to N instances of FIM 202. With master hardware 112 serving as a bridge in the initialization flow, the initialization process executed by controller 108 may be faster. Controller 108 may thus be able to perform core initialization of the multiple hardware instances that have the same configuration setting with single setup of master hardware 112.

Controller 108 may thereafter fine special tune one or more hardware instances (referred to herein as a first hardware instance). For example, after initializing FIMs 202A-202N via master hardware 112, controller 108 may initiate direct communication with FIM 202A to update/change the values in one or more of the registers in FIM 202A. As indicated above FIG. 2 is provided as an example. Other examples may differ from what is described in FIG. 2.

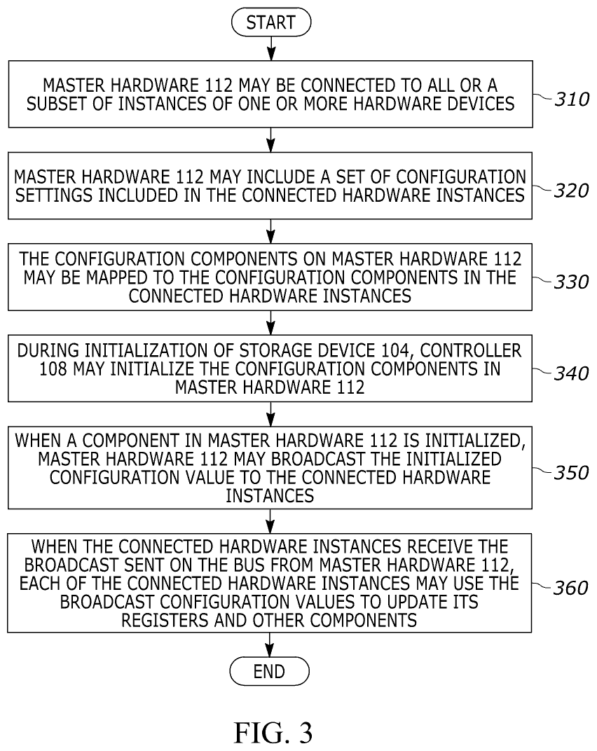

FIG. 3 is an example flow diagram for configuring multiple hardware instances in parallel with one processor during initialization of a storage device in accordance with some implementations. At 310, master hardware 112 may be connected to all or a subset of instances of one or more hardware devices. At 320, master hardware 112 may include a set of configuration settings included in the connected hardware instances. At 330, the configuration components on master hardware 112 may be mapped to the configuration components in the connected hardware instances. At 340, during initialization of storage device 104, controller 108 may initialize the configuration components in master hardware 112. At 350, when a component in master hardware 112 is initialized, master hardware 112 may broadcast the initialized configuration value to the connected hardware instances. At 360, when the connected hardware instances receive the broadcast sent on the bus from master hardware 112, each of the connected hardware instances may use the broadcast configuration values to update its registers and other components. As indicated above FIG. 3 is provided as an example. Other examples may differ from what is described in FIG. 3.

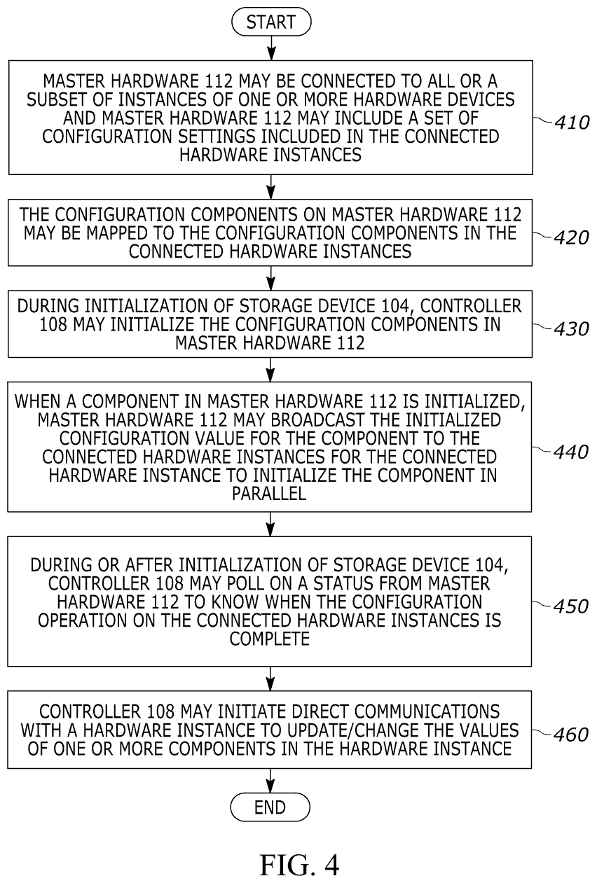

FIG. 4 is another example flow diagram for configuring multiple hardware instances in parallel with one processor during initialization of a storage device in accordance with some implementations. At 410, master hardware 112 may be connected to all or a subset of instances of one or more hardware devices and master hardware 112 may include a set of configuration settings included in the connected hardware instances. At 420, the configuration components on master hardware 112 may be mapped to the configuration components in the connected hardware instances. At 430, during initialization of storage device 104, controller 108 may initialize the configuration components in master hardware 112. At 440, when a component in master hardware 112 is initialized, master hardware 112 may broadcast the initialized configuration value for the component to the connected hardware instances for the connected hardware instance to initialize the component in parallel. At 450, during or after initialization of storage device 104, controller 108 may poll on a status from master hardware 112 to know when the configuration operation on the connected hardware instances is complete. At 460, controller 108 may initiate direct communications with a hardware instance to update/change the values of one or more components in the hardware instance. As indicated above FIG. 4 is provided as an example. Other examples may differ from what is described in FIG. 4.

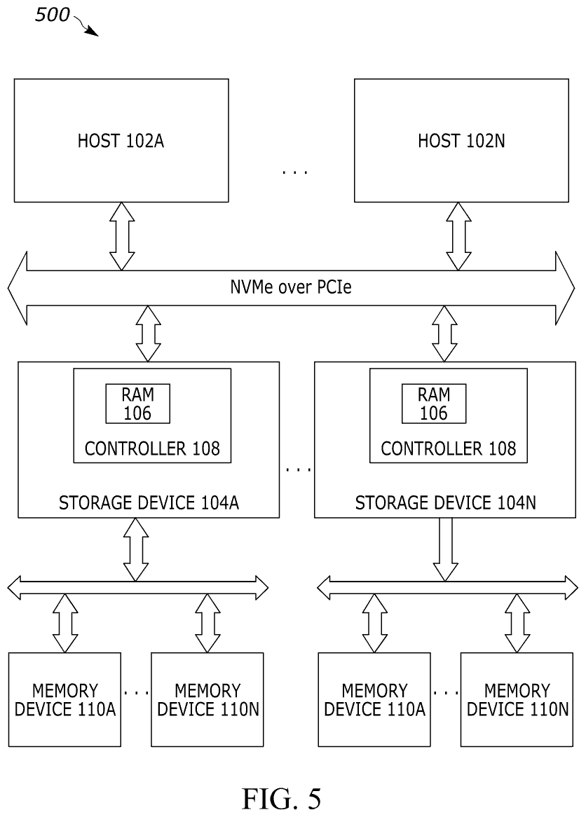

FIG. 5 is a diagram of an example environment in which systems and/or methods described herein are implemented. As shown in FIG. 5, Environment 500 may include hosts 102a-102n (referred to herein as host(s) 102), and one or more storage devices 104a-104n (referred to herein as storage device(s) 104). Storage device 104 may include a controller 108 to configure multiple hardware instances in parallel during initialization of storage device 104. Hosts 102 and storage devices 104 may communicate via Non-Volatile Memory Express (NVMe) over peripheral component interconnect express (PCI Express or PCIe), SD, or the like.

Devices of Environment 500 may interconnect via wired connections, wireless connections, or a combination of wired and wireless connections. For example, the network in FIG. 5 may include NVMe over Fabric(NVMe-oF) Internet Small Computer Systems Interface(iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of Environment 500 may perform one or more functions described as being performed by another set of devices of Environment 500.

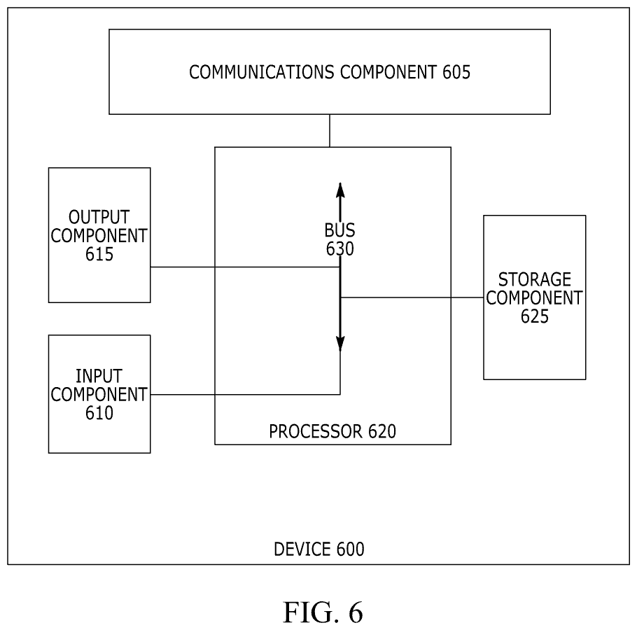

FIG. 6 is a diagram of example components of one or more devices of FIG. 1. In some implementations, host 102 may include one or more devices 600 and/or one or more components of device 600. Device 600 may include, for example, a communications component 605, an input component 610, an output component 615, a processor 620, a storage component 625, and a bus 630. Bus 630 may include components that enable communication among multiple components of device 600, wherein components of device 600 may be coupled to be in communication with other components of device 600 via bus 630.

Input component 610 may include components that permit device 600 to receive information via user input (e.g., keypad, a keyboard, a mouse, a pointing device, and a network/data connection port, or the like), and/or components that permit device 600 to determine the location or other sensor information (e.g., an accelerometer, a gyroscope, an actuator, another type of positional or environmental sensor). Output component 615 may include components that provide output information from device 600 (e.g., a speaker, display screen, and network/data connection port, or the like). Input component 610 and output component 615 may also be coupled to be in communication with processor 620.

Processor 620 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 620 may include one or more processors capable of being programmed to perform a function. Processor 620 may be implemented in hardware, firmware, and/or a combination of hardware and software.

Storage component 625 may include one or more memory devices, such as random-access memory (RAM 106), read-only memory (ROM), and/or another type of dynamic or static storage device (e.g., a flash memory, a magnetic memory, and/or optical memory) that stores information and/or instructions for use by processor 620. A memory device may include memory space within a single physical storage device or memory space spread across multiple physical storage devices. Storage component 625 may also store information and/or software related to the operation and use of device 600. For example, storage component 625 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 605 may include a transceiver-like component that enables device 600 to communicate with other devices, such as via a wired connection, a wireless connection, or a combination of wired and wireless connections. The communications component 605 may permit device 600 to receive information from another device and/or provide information to another device. For example, communications component 605 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 605 may also include one or more broadband and/or narrowband transceivers and/or other similar types of wireless transceiver configurable to communicate via a wireless network for infrastructure communications. Communications component 605 may also include one or more local area network or personal area network transceivers, such as a Wi-Fi transceiver or a Bluetooth transceiver.

Device 600 may perform one or more processes described herein. For example, device 600 may perform these processes based on processor 620 executing software instructions stored by a non-transitory computer-readable medium, such as storage component 625. As used herein, the term “computer-readable medium” refers to a non-transitory memory device. Software instructions may be read into storage component 625 from another computer-readable medium or from another device via communications component 605. When executed, software instructions stored in storage component 625 may cause processor 620 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to initialize multiple instances of a hardware device during initialization of the storage device, the storage device comprises:
a hardware device including multiple instances with a set of configuration settings, the set of configuration settings being one of a same configuration setting and an overlapping configuration setting in the multiple instances;
a master device connected to a set of instances of the hardware device and including the set of configuration settings of connected hardware instances, wherein the set of configuration settings are to be initialized during initialization of the storage device; and
a controller to initialize the set of configuration settings in the master device when initializing the storage device,
when the set of configuration settings in the master device are initialized, the master device broadcasts initialized values in the set of configuration settings in the master device to each instance in the set of instances for the instance to initialize its configuration settings.

2. The storage device of claim 1, wherein each instance in the set of instances is associated with a physically unique memory address.

3. The storage device of claim 1, wherein the master device knows the set of instances it is connected to and an address of each connected instance.

4. The storage device of claim 1, wherein the master device maps the set of configuration settings in the master device with the set of configuration settings in the set of instances.

5. The storage device of claim 1, wherein an input/output line on a bus between the master device and the set of instances is associated with a configuration setting in the master device.

6. The storage device of claim 5, wherein the master device broadcasts an initialized value for a configuration setting on the input/output line.

7. The storage device of claim 1, wherein, during initialization of the storage device, each instance in the set of instances listens to input/output lines on a bus between the master device and the set of instances and uses values transmitted on the input/output lines to update the set of configuration settings in the instance in parallel with other instances in the set of instances.

8. The storage device of claim 1, wherein the hardware device is a flash interface module with multiple instances, wherein configuration settings on the multiple instances are set when the storage device is initialized.

9. The storage device of claim 1, wherein the set of configuration settings in the master device broadcasts are associated with more than one hardware device.

10. A storage device to initialize multiple instances of a hardware device during initialization of the storage device, the storage device comprises:
a hardware device including multiple instances with a set of configuration settings, the set of configuration settings being one of a same configuration setting and an overlapping configuration setting in the multiple instances;
a master device connected to a set of instances of the hardware device and including the set of configuration settings of connected hardware instances, the set of configuration settings to be initialized during initialization of the storage device; and
a controller to initialize the set of configuration settings in the master device when initializing the storage device,
a controller to initialize the configuration settings of the connected hardware instances in the master device when initializing the storage device,
when the configuration settings in the master device are initialized, the master device broadcasts initialized values in the configuration settings in the master device to each instance in the set of instances for the instance to initialize its configuration settings in parallel with other instances in the set of instance, and
the controller establishes direct connection with a first instance to update a configuration setting in the first instance.

11. The storage device of claim 10, wherein the controller polls on a status from the master device to know when a configuration operation for the set of instances is complete.

12. The storage device of claim 10, wherein during a wait time, the controller performs other setup tasks to overlap initialization sequences.

13. The storage device of claim 10, wherein the controller establishes direct connection with the first instance to perform error recovery on configuration settings on the first instance.

14. The storage device of claim 10, wherein the controller establishes direct communication via hardware mapped locations that map each instance to an addressable memory region this is accessible by the controller.

15. A method for initializing multiple instances of a hardware device during initialization of a storage device, the storage device comprises a controller and a master device to execute the method comprising:
connecting, by a master device, to a set of instances of a hardware device, the set of instances having a set of configuration settings, the set of configuration settings being one of a same configuration setting and an overlapping configuration setting in the set of instances;
including, by the controller, the set of configuration settings of connected hardware instances. in the master device. the set of configuration settings to be initialized during initialization of the storage device;
initializing, by the controller, the set of configuration settings in the master device when initializing the storage device; and
broadcasting, by the master device, initialized values in the set of configuration settings in the master device to each instance in the set of instances for the instance to initialize its configuration settings, when the configuration settings in the master device are initialized.

16. The method of claim 15, further comprising mapping the set of configuration settings in the master device with the set of configuration settings in the set of instances.

17. The method of claim 15, further comprising associating an input/output line on a bus between the master device and the set of instances with a configuration setting in the master device.

18. The method of claim 17, further comprising broadcasting, by the master device, an initialized value for the configuration setting on the input/output line.

19. The method of claim 15, further comprising listening, by each instance in the set of instances, to input/output lines on a bus between the master device and the set of instances and using values transmitted on the input/output lines to update the set of configuration settings on the instance in parallel with other instances in the set of instances during initialization of the storage device.

20. The method of claim 15, further comprising updating, by the controller, a value in a first hardware instance.
